(19) United States
(12) Patent Application Publication
(10) Pub. No.: US 2007/0249762 A1
(43) Pub. Date: Oct. 25, 2007

(54) Rubber modified asphalt cement compositions and methods

(75) Inventor: Laurence M. Sylvester, Tiburon, CA (US)

Correspondence Address: STOUT, UXA, BUYAN & MULLINS LLP, 4 VENTURE, SUITE 300, IRVINE, CA, 92618, US

(73) Assignee: RAM Technologies Group, Inc., Tiburon, CA (US)

(21) Appl. No.: 11/484,334

(22) Filed: Jul. 10, 2006

Related U.S. Application Data
(63) Continuation-in-part of application No. 10/735,276, filed on Dec. 12, 2003, now Pat. No. 7,074,846.
Application No. 10/735,276 is a continuation-in-part of application No. 10/652,725, filed on Aug. 29, 2003, now Pat. No. 7,087,665.
(60) Provisional application No. 60/432,972, filed on Dec. 12, 2002.
(60) Provisional application No. 60/406,760, filed on Aug. 29, 2002.

(51) Int. Cl. C08L 95/00

(52) U.S. Cl. 524/71

(57) ABSTRACT

Rubber modified asphalts and their methods of manufacture. One or more sulfonic acids is/are added to a mixture of asphalt and rubber particles, or to an existing rubber modified asphalt composition. Heat and/or mixing may be applied during or after addition of the sulfonic acid(s).

### RELATED APPLICATIONS

This patent application is a continuation in part of U.S. patent application Ser. No. 10/735,276 filed on Dec. 12, 2003, which claims priority to U.S. Provisional Patent Application Ser. No. 60/432,972 filed on Dec. 12, 2002 and which is a continuation in part of copending U.S. patent application Ser. No. 10/652,725 filed on Aug. 29, 2003 which claims priority to U.S. Provisional Patent Application No. 60/406,760 filed on Aug. 29, 2002, the entireties of which are expressly incorporated herein by reference.

### FIELD OF THE INVENTION

The present invention generally relates to methods of making improved rubber modified asphalt cement compositions, and compositions made by the method, where the compositions are useful in paving, roofing, coating and other sealing applications.

### BACKGROUND OF THE INVENTION

Ever since the first United States Patent was issued in 1930 to Samuel Sadtler (U.S. Pat. No. 1,758,913) for a rubber and asphalt mixture for use as a road surface product, the asphalt industry has continued to devise new methods for the production of rubber modified asphalt cement (RMAC).

To date, some of the processes for producing RMAC include the addition of solubilized rubber crumb (U.S. Pat. No. 5,798,394, Meyers et al.) gelled crumb rubber (U.S. Pat. No. 3,891,585, McDonald), melted crumb rubber (U.S. Pat No. 5,492,561, Flanigan I) (U.S. Pat. No. 5,334,641, Rouse), mechanically sheared (U.S. Pat. No. 6,66,676, Rouse et al.), and/or acid treated asphalt (U.S. Pat. No. 5,095,055, Moran) for incorporating vulcanized rubber into asphalt. Memon (U.S. Pat. No. 6,444,731) teaches addition of a dispersion agent, such as furfural and/or vegetable oil) to the crumb rubber material, which is then heated at elevated temperatures that can be as high as 1500° C., to ensure the rubber is fully treated with the dispersion agent. The treated rubber is then added to hot asphalt, after which an activator (a Lewis acid that contains a trace of sulfur) and a micro-activator (phenyl formaldehyde resin) are added and mixed, to achieve a modified asphalt.

Although prior art processes have made some inroads in improved production of RMAC, the hurdle remains to find a way to devulcanize recycled vulcanized particulate rubber (RVPR) and incorporate it into the asphalt in a single step process. Such a process should not degrade the asphalt or the rubber through the use of high temperatures, require highly sophisticated equipment or release harmful toxins into the air.

### SUMMARY OF THE INVENTION

In accordance with the present invention, there is provided a method for making RMAC comprising the steps of A) combining asphalt, rubber particles and at least one benzene sulfonic acid (SA) and B) heating such mixture to form RMAC. In some embodiments, the mixture of asphalt, rubber particles and one or more SA(s) is heated to a temperature in the range of from about 225 degrees F to about 450 degrees F. (ca. 107 degrees C. to about 232 degrees C.), typically at about 350 degrees F. (ca. 177° C.). The mixture may be heated for any suitable time, typically for about 1-2 hours, or until the resultant RMAC mixture exhibits at least one of the following properties: (1) an increase in softening point, (2) an increase in hardness, or (3) improved recovery from deformation. For paving compositions, the resultant RMAC mixture is mixed with an appropriate grade of aggregate composition, and other paving materials as desired. The resultant RMAC may also be emulsified in an aqueous solution to form an emulsion or seal coat.

Further in accordance with the present invention, there is provided a method for treating an existing or previously manufactured RMAC composition by adding one or more SA(s) to the RMAC in amount(s) and under conditions that are sufficient to cause at least one of the following in the resultant improved RMAC: (1) an increase in the softening point, (2) an increase in the hardness, or (3) an improvement in the recovery from deformation, of the resulting improved RMAC compositions. This aspect of the invention includes a method for improving at least one of (1) the softening point, (2) the hardness, or (3) the recovery from deformation of a RMAC composition comprising adding at least one benzene sulfonic acid (SA), in the amount of from about 1 to about 10 percent, W/W, to the RMAC in the presence of moderate heat (about 225 degrees F to about 450 degrees F. (ca. 107 degrees C. to about 232 degrees C.)) for about 1-4 hours, and improved RMAC compositions made by this method.

Still further in accordance with the present invention, the rubber particles used in the foregoing methods may be obtained from any suitable source, including but not limited to virgin rubber and/or natural rubber and/or recycled rubber. In embodiments where recycled rubber is used, such recycled rubber may comprise crumb rubber or other particulate rubber (e.g., rubber shavings, beads, etc.) obtained from articles such as used tires, inner tubes, gaskets, rubber scrap, etc.

Still further in accordance with the present invention, the SA(s) used in the foregoing methods may comprise any suitable sulfonic acid(s) including but not limited to; dodecylbenzene sulfonic acid (DDBSA or DBSA), tridecylbenzene sulfonic acid (TDBSA), methane sulfonic acid (MSA, 4-methylbenzenesulfonic acid, dimethylbenzene sulfonic acid, toluene sulfonic acid, para-toluene sulfonic acid, methane sulfonic acid and other sulfonic acids.

Further aspects, objects and advantages of the present invention may be apparent to those of skill in the relevant art upon reading the detailed description and examples set forth herebelow.

### BRIEF DESCRIPTION OF THE DRAWINGS

FIG. 1 is a diagram of the experimental apparatus used in Example 4 below.

FIG. 2 is a graph of % volume vs. rubber particle diameter in an RMAC emulsion treated with para-toluene sulfonic acid (p-TSA) as described in Example 8 below.

FIG. 3 is a graph of % volume vs. rubber particle diameter in an RMAC emulsion treated with dodecylbenzene sulfonic acid (DDBSA) as described in Example 8 below.

### DETAILED DESCRIPTION AND EXAMPLES

The following detailed description with examples, and the accompanying drawings and tables to which it refers, are provided for the purpose of describing and illustrating certain examples or specific embodiments of the invention only and not for the purpose of exhaustively describing all possible embodiments and examples of the invention. Thus, this detailed description with examples does not in any way limit the scope of the inventions claimed in this patent application or in any patent(s) issuing form this or any related application.

In general, this invention provides rubber modified asphalt materials to which one or more sulfonic acids have been added. Any suitable sulfonic acids may be ised, including but not limited to: dodecylbenzene sulfonic acid (DDBSA or DBSA), tridecylbenzene sulfonic acid (TDBSA), 4-methylbenzenesulfonic acid, dimethylbenzene sulfonic acid, toluene sulfonic acid, para-toluene sulfonic acid, methane sulfonic acid and other sulfonic acids.

In one embodiment of the invention, asphalt, rubber particles and at least one method of the invention comprises combining asphalt, sulfonic acid (AS), which can be linear (LAS) or branched (BAS), in the presence of moderate heat. Preferably, the mixture of asphalt, RVPR and the SA(s) are heated at temperatures of about 225□ to about 450 degrees F. (ca. 107 degrees C. to about 232 degrees C.), most preferably at about 350 degrees F. (ca. 177° C.). The mixture is heated, preferably for about 1-2 hours, or until the resultant RMAC mixture exhibits at least one of the following: (1) an increase in softening point, (2) an increase in hardness, or (3) improved recovery from deformation. For paving compositions, the resultant RMAC mixture is mixed with an appropriate grade of aggregate composition, and other paving materials as desired. The resultant RMAC may also be emulsified in an aqueous solution to form a seal coat. In some embodiments, the sulfonic acid may be a benzene sulfonic acid such as 4-methylbenzenesulfonic acid with a molecular weight of about 200 or a combination of sulfonic acids such as a toluene sulfonic containing approximately from about 50% to 65% by weight of 4-methylbenzenesulfonic acid together with from about 30% to 45% by weight of dimethylbenzene sulfonic acid and a combined molecular weight of about 172 or para-toluene sulfonic acid or methane sulfonic acid with a molecular weights ranging from about 80 to 175. One commercially available methane sulfonic acid that may be used is 99% Methane Sulfonic Acid (MSA) having a molecular formula of CH₄O₃S and a molecular with of 96.1 available from Richman Chemical, Inc., Gwynedd, Pa.

### EXAMPLE 1

### Method

A. 400 grams of asphalt (AR4000, San Joaquin Refining, Bakersfield, Calif.), with a softening point of 118° F. (ca. 48° C.) and a penetration of 33 at 77° F. (25° C.) was heated for about 60 minutes at about 350° F. (ca. 177° C.) until it was free flowing and then mixed with 59.77 grams of 80 mesh crumb rubber (BAS Recycling, Inc., San Bernardino, Calif.).

B. A portion of the mixture was then drawn off and tested.

C. 18.39 grams of DDBSA (Pilot Chemical, Inc., Santa Fe Springs, Calif.) was then added all at once to the non-drawn off and remaining portion of the rubber/asphalt mixture, which was then continuously blended with a simple propellor mixer for a period of about 2 hours at a temperature of about 350° F. (ca. 177° C.).

### Result

The addition of the DDBSA increased the softening point and hardness of the compositions. The test results are set forth in the following table.

| | Composition | Penetration | Softening Point |
|---|---|---|---|
| A | Asphalt Alone | 33 | 118° F. (ca. 48° C.) |
| B | Asphalt/Rubber | 29 | 141° F. (ca. 61° C.) |
| C | Asphalt/Rubber/DDBSA | 22 | 153° F. (ca. 67° C.) |

### EXAMPLE 2

### Method

604.7 grams of asphalt (AR4000, Paramount Petroleum Company, Paramount, Calif.), with a softening point of 117° F. (ca. 47° C.) and a penetration of 47 at 77° F. (25° C.) was heated at about 350° F. (ca. 177° C.) for about 60 minutes until it was free flowing and then mixed with 66.52 grams of 20 mesh crumb rubber (BAS Recycling, Inc., San Bernardino, Calif.) together with 24.188 grams of DDBSA (Pilot Chemical, Inc. Santa Fe Springs, Calif.). The rubber/asphalt/DDBSA mixture was heated to a temperature of about 350° F. (ca. 177° C.) and mixed with a simple propellor mixer. Samples were drawn and tested at elapsed times of 0.5 hours, 1 hour, 2 hours and 3 hours. The changes occurring in the mixture as exhibited by the corresponding test are included in the table below.

| Heat Time and Sample | Penetration | Softening Point |
|---|---|---|
| No heat, Original Mixture (OM) | 47 | 117° F. (ca. 47° C.) |
| 0.5 hour heat + OM + DDBSA | 27 | 152° F. (ca. 67° C.) |
| 1.0 hour heat + OM + DDBSA | 26 | 150° F. (ca. 66° C.) |
| 2.0 hour heat + OM + DDBSA | 26 | 150° F. (ca. 66° C.) |
| 3.0 hour heat + OM + DDBSA | 26 | 147° F. (ca. 64° C.) |

### EXAMPLE 3

### Method.

A blended and homogenous mixture of RMAC containing approximately 13.25% crumb rubber from recycled tires (MAC10-TR) was reacted with increasing percentages (by weight) of DDBSA. The mixtures were mixed with a simple propeller mixer and heated at a temperature of about 350° F. (ca. 177° C.) for about 60 minutes.

### Results

These tests demonstrate that the greater the amount of DDBSA, the higher the softening point and the greater the penetration. Results are summarized in the table below.

| | | Penetration | |
|---|---|---|---|
| | % | @ 77° F. | |
| Sample | DDBSA | (25° C.) | Softening Point |
| MAC 10-TR, W/O DDBSA | 0 | 46 | 124° F. (ca. 51° C.) |
| MAC 10-TR, W/2% | 2 | 33 | 150° F. (ca. 66° C.) |
| DDBSA | | | |
| MAC 10-TR, W/4% | 4 | 20 | 152° F. (ca. 67° C.) |
| DDBSA | | | |
| MAC 10-TR, W/6% | 6 | 23 | 163° F. (ca. 73° C.) |
| DDBSA | | | |

### EXAMPLE 4

### DDBSA (Which is also Known as DBSA) Reactions with Asphalt and Crumb Rubber

### Summary:

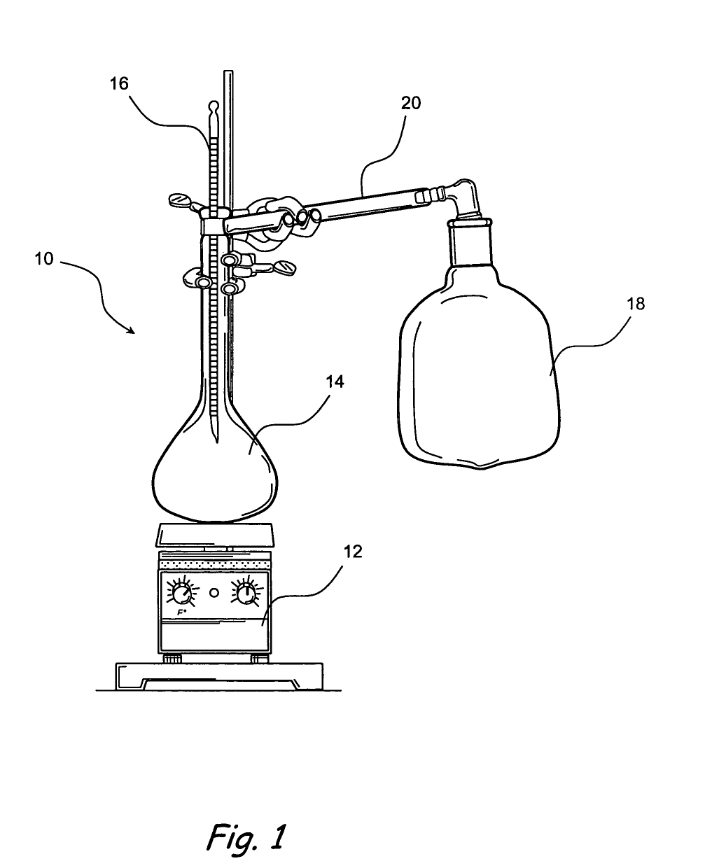

Several experiments were carried out to determine the nature of gases evolved (if any) when asphalt was heated to about 300° F. (ca. 149° C.) by itself, when DBSA was heated to the same temperature by itself, then with asphalt, with crumb rubber, and finally with both asphalt and rubber crumb. Gasses evolved were trapped in tedlar bags attached to the closed system being heated. FIG. 1 is a diagram of the experimental set up 10 which comprised a hot plate/magnetic stirrer base 12, a sealed flask 14, a thermometer 16, a sealed bag 18 (i.e., a Tedlar bag) and a tube 20 connecting the interior of the flask 14 to the interior of the bag 18. Asphalt and DDBSA were combined in the flask and heated to about 300° F. (ca. 149° C.). Foaming occurred in flask 14 and elemental sulfur was deposited on the cooled glassware, but no gasses were observed to collect in the bag 18. When a mixture of crumb rubber and DDBSA were placed in the flask 14 and heated to around 300° F. (ca. 149° C.), elemental sulphur and gases containing hydrocarbons and sulfur compounds were evolved and collected in the bag 18. When crumb rubber, asphalt and DDBSA were combined in the flask and heated to a temperature of about 300° F. (ca. 149° C.), foaming occurred in the flask and evidence of formation of elemental sulphur and evolved gases were observed to collect in the bag 18. These major hydrocarbon gases and sulphur containing gasses were identified by gas chromatography/and mass spectrometry (GC/MS). This involves separating the gases from each other (GC), then identifying the gas after it had been bombarded with electrons (MS) with the help of a computerized catalogue containing spectra of about 80,000 compounds.

These preliminary experiments revealed that the role of DBSA in the reaction involving crumb rubber and asphalt appears to be de-vulcanization of the rubber crumb. DBSA also has the capability to catalyze reactions of the de-vulcanized rubber with molecules present in asphalt (particularly any molecules with double bonds.) This catalytic role can apparently continue even after the rubber asphalt has been emulsified (i.e., carbon to carbon bond formation can continue even in the presence of water). As a strong surfactant, DBSA would stabilize the asphaltenes (and hence the entire system) in an asphalt-rubber system. The presence of DDBSA when the asphalt-rubber mixture is emulsified may provide additional emulsion stability.

There was no evidence of gas evolution when duplicate samples of DBSA (50 grams of material provided by Ram Technologies) were heated for 45 minutes at temperatures ranging between 138 [symbol] C (280 [symbol] F) and 175 [symbol] C (347 [symbol] F). In other words, the tedlar bag did not become inflated during that time.

Similarly, there was no evidence of gases being evolved and trapped by the attached tedlar bag when asphalt (50 grams PG58-28 from McAsphalt Industries in Winnipeg) was heated alone at 149-152 C (300-306 F) for 15 minutes.

### Experimental:

Asphalt Heated with DBSA

DBSA was added to asphalt (500 grams of PG58-28 from McAsphalt Industries in Winnipeg) that had been heated in a flask to 149 C (300 F), and the system rapidly closed again to allow the bubbling gases to enter the tedlar bag. The asphalt-DBSA mixture continued to be stirred for 43 minutes (as long as some foam bubbles were still being formed on the surface of the asphalt) at temperatures that ranged between 147 and 155 C (297-311 F). In spite of all the bubbling and foaming that was taking place in the flask, there was no evidence of gas being collected—the tedlar bags remained uninflated. This was true whether 8.5 grams or 26.1 grams of DBSA had been added to the flask containing 500 grams asphalt. However, there was evidence of some milky liquid condensing on the walls of the flask.

Peak area is generally proportional to concentration. Approximate concentrations were calculated assuming that the peak areas were directly proportional to mass.

TABLE 1
Identity and Normalized Approximate % Concentration* of the 10–12 Largest
Peaks in the Sample as Detected by a Capillary Gas Chromatograph-Mass
Selective Detector

| | Reactants | | | |
|---|---|---|---|---|
| | | | PG58-28 Asphalt + Rubber | PG58-28 Asphalt + Rubber |
| | | | Crumb + DBSA, | Crumb + DBSA, |
| | Rubber Crumb + DBSA | Rubber Crumb + DBSA | Run 1 | Run 2 |
| | (t = 0–12 minutes at | (t = 12–195 min. at | (t = 130 minutes at | (t = 126 minutes at |
| | 140°–199° C. or | 149°–210° C. or | 144–168° C. or | 141–158° C. or |
| Compound | 284–390° F.) | 300–410° F.) | 291–334°P) | 286–316°P) |
| 2-methyl propane | 9.33 | 32.81 | 0.92 | 0.30 |
| 2-methyl-1-propene | 6.28 | 18.41 | 0.44 | 0.46 |
| 2-methyl butane | 1.97 | 2.51 | 3.19 | 0.24 |
| butane | — | — | 4.76 | 0.34 |
| 2-methyl-1-butene | 0.94 | 3.56 | 0.45 | — |
| pentane | — | — | 0.98 | — |
| 2-pentene | — | — | 0.41 | — |
| 2-methyl pentane | — | 1.78 | 0.87 | 0.26 |
| 2-methyl-2-pentene | 0.65 | 2.06 | — | — |
| 2,4,4-trimrthyl-1- | 0.75 | 1.91 | — | — |
| pentene | | | | |
| 2,3,4-trimrthyl-2- | 1.36 | 2.59 | — | — |
| pentene | | | | |
| 2,2-dimethyl hexane | — | — | — | 0.22 |
| 3,4-dimethyl hexane | — | — | 0.51 | — |
| 2,5-dimethyl-2-hexane | 0.83 | 2.13 | — | — |
| 2-methyl-2- | 0.57 | | | |
| propanethiol | | | | |
| Carbon disulfide | — | — | — | 0.21 |
| Hydrogen sulfide | — | 4.74 | 1.67 | 2.88 |
| Sulfur dioxide | 5.31 | — | — | — |
| Air (oxygen, nitrogen, | 72.02 | 27.49 | 85.80 | 95.07 |
| carbon dioxide + argon) | | | | |

*Peak area is generally proportional to concentration. Approximate concentrations were calculated assuming that the peak areas were directly proportional to mass

From the results in Table I, it appears that air (displaced from the rubber crumb surface) made up most of the gas filling the bag 18 in the first 12 minutes of the reaction. After that, pyrolysis gases like 2methyl propane and 2-methyl propene from the decomposition of rubber crumb in the presence DBSA began to dominate the gases evolved. In the presence of asphalt, however, it appears that while some of these molecules are still evolved from the rubber crumb, many appear to have been either absorbed into the asphalt or reacted with molecules in the asphalt. It must be noted, however, that temperatures of mixtures in asphalt were much easier to control than temperatures of the DBSA-rubber crumb mixture, which rose uncontrollably high, leading to significant pyrolysis of the rubber crumb.

Since no gases had been evolved when DBSA was heated with asphalt alone, the gases collected when DBSA was heated with asphalt and rubber crumb would likely have come from the rubber crumb.

In the flask 12 containing 500 g asphalt and 26.1 g DBSA, an attempt was made to encourage evolving gaseous (or liquid) materials to enter the tedlar bags instead of condensing on the flask walls. The top and neck of the flask were wrapped to insulate the area in the flask above the hot asphalt and heating was continued for a further two hours. This resulted in the deposition of a thin cream coloured solid layer in the glass side arm of the adapter and in the glass tubing acting as an adapter to connect the side arm to the flexible tubing connected to the tedlar bag. This cream-coloured solid sublimed off the glass surfaces within a day at room temperature. This is strong evidence that su∪ur present in asphalt had been released when asphalt was heated in the presence of the DBSA. However, there was no evidence of bag 18 inflation even after of two hours and 42 minutes of heating asphalt with DBSA at temperatures that ranged between 141 and 155 C (286-311 F).

### Rubber Crumb Heated with DBSA

When rubber crumb (80 mesh, 66 grams) was combined with DBSA (31.1 grams), not all the rubber crumb was wetted by DBSA, resulting in uneven heat transfer within the mass inside the flask 12. Temperature control was difficult. As heating progressed, some small areas of wetness and bubbling appeared in a few areas of the rubber mass. As each bubble broke, a puff of smoke issued forth. Within an eight minute period, the measured temperature in one area of the rubber mass rose from 140 C (284 F) to 199 C (390 F). The first bag 18 rapidly filled with gas and was replaced with a second bag 18 after twelve minutes. The measured temperatures ranged between 149 C (300 F) and 210 C (410 F) over the next three hours and 3 minutes as gases were collected in the second bag 18.

The top part of the flask 12 had been insulated to allow evolving gases to pass into the second bag 18. When the heating was ended and insulation removed, a creamy colored condensate was observed moving down the neck of the flask 12. A sulfurous smell came forth when the adapter was removed from the flask 12 to expose the flask contents to the air.

Heating Asphalt with Rubber Crumb and DBSA Rubber crumb (80 mesh, 66 grams) was mixed with DBSA (29.3 and 32.7 grams respectively added to Flasks I and 2) and then added to flasks of pre-heated asphalt (430 grams of PG58-28, preheated to 120 C [248 F], in each of Flasks I and 2). The system was rapidly closed and connected to tedlar bags that were opened immediately to collect any evolving gases produced. Occasional gentle manual flask shaking was needed to supplement the magnetic stirring to incorporate the rubber crumb into the asphalt. Foaming and bubbling increased as the mixture was heated and stirred. Heating in Flask I continued for 130 minutes, maintaining temperatures between 144.5 and 168 C (292-334 F). Heating in Flask 2 continued for 126 minutes, with temperatures ranging between 141 and 158 C. Both tedlar bags showed evidence of some gas having been collected. A cream coloured condensate was observed on the upper (cooler) parts of the flask.

### Analyses of Volatile Reaction Products:

The four bags 18 that showed evidence of having collected gases were analyzed for volatile organic compounds and for sulfur compounds by GC/MS as mentioned earlier. The results of these analyses are shown in Tables I and 2.

TABLE 2
Sulfer Compound Gas Analysis
Identity and Normalized % Concentration of Sulfur Compounds in Gasses Evolved

| | Reactants | | | |
|---|---|---|---|---|
| | | | PG58-28 Asphalt + Rubber | PG58-28 Asphalt + Rubber |
| | | | Crumb + DBSA, | Crumb + DBSA, |
| | Rubber Crumb + DBSA | Rubber Crumb + DBSA | Run 1 | Run 2 |
| | (t = 0–12 minutes at | (t = 12–195 min. at | (t = 130 minutes at 144–168° C. | (t = 126 minutes at |
| | 140°–199° C. or | 149°–210° C. or | or | 141–158° C. or |
| Compound | 284–390° F.) | 300–410° F.) | 291–334°P) | 286–316°P) |
| Carbon disulfide | 13.6 | 6.21 | 1.79 | 1.14 |
| Hydrogen sulfide | 55.2 | 82.3 | 96.96 | 97.80 |
| Sulfur dioxide | —* | — | — | — |
| Methyl mercaptan | 0.30 | 0.27 | 0.15 | 0.22 |
| Ethyl mercaptan | 1.43 | 0.08 | 0.15 | 0.06 |
| n-propyl mercaptan | — | 0.02 | — | — |
| i-propyl mercaptan | 0.39 | 0.19 | — | 0.04 |
| n-butvl mercaptan | 1.67 | 1.26 | — | 0.03 |
| Sec-butyl | 0.23 | 0.06 | — | 0.03 |
| mercaptan | | | | |
| t-butyl mercaptan | 26.85 | 9.22 | 0.95 | 0.64 |
| Dimethyl sulfide | 0.14 | 0.26 | — | 0.03 |
| Methylethyl sulfide | — | 0.08 | — | — |
| Diethvl sulfide | 0.25 | 0.07 | — | 0.01 |

*Inconsistent with the findings of major peaks for this sample as shown in Table I

From Table 2, it is apparent that the reaction of rubber crumb with either rubber crumb or with asphalt in the presence of DBSA produces a number of sulfur-containing compounds, with hydrogen sulfide being by far the most dominant species. Since only solid sulfur but no gases had been evolved during the heating of asphalt alone with DBSA, it appears that that the sulfur-containing gases evolved during the heating of asphalt, rubber crumb and DBSA would have originated from the rubber crumb.

Crumb rubber consists of vulcanized polymers obtained from the treads of tires. Tire rubber vulcanization involves using sulfur to cross-link the polymers, which are mainly a blend of butadiene and styrenebutadiene-styrene polymers. The presence of hydrogen sulfide and other sulfur-containing compounds in the gases evolved when rubber crumb was heated in asphalt in the presence of DBSA is a strong indicator that rubber crumb is being de-vulcanized—the sulfur cross-links are being eliminated—during the process.

### Conclusion

The role of DBSA in the reaction involving rubber crumb and asphalt appears to be de-vulcanization of the rubber crumb. DBSA also has the capability to catalyze reactions of the de-vulcanized rubber with molecules present in asphalt (particularly any molecules with double bonds). This catalytic role can apparently continue even after the rubber asphalt has been emulsified (i.e. carbon to carbon bond formation can continue even in the presence of water). As a strong surfactant, DBSA would be effective in stabilizing the asphaltenes (and hence the asphalt) within the rubber-asphalt mixture. Furthermore, in an emulsion, DBSA can then play the role of an additional emulsifier, which may be important in maintaining emulsion stability.

### EXAMPLE 5

Tables 3 and 4 below list various aggregates Aggregate Compositions That May Be Mixed With the Improved Rubber Modified Asphalt Cement Compositions of the Present Invention.

TABLE 3
Open Graded Aggregate

| 12.5-mm Maximum | | | 9.5-mm Maximum | | |
|---|---|---|---|---|---|
| | Limits of | | | Limits of | |
| Sieve | Proposed | Operating | | Proposed | Operating |
| Sizes | Gradation | Range | Sieve Sizes | Gradation | Range |
| 19-mm | — | 100 | 12.5-mm | — | 100 |
| 12.5-mm | — | 95–100 | 9.5-mm | — | 90–100 |
| 9.5-mm | 78–89 | X +/− 4 | 4.75-mm | 29–36 | X +/− 4 |
| 4.75-mm | 28–37 | X +/− 4 | 2.36-mm | 7–18 | X +/− 4 |
| 2.36-mm | 12–18 | X +/− 4 | 600-um | — | 0–10 |
| 600-um | — | 0–10 | 75-um | — | 0–3 |
| 75-um | — | 0–3 | | | |

Types A and B Asphalt Concrete Base
Percentage Passing

| | Limits of | |
|---|---|---|
| | Proposed | Operating |
| Sieve Sizes | Gradation | Range |
| 31.5-mm | — | 100 |
| 25-mm | — | 95–100 |
| 19-mm | — | 80–100 |
| 9.5-mm | 55–60 | X +/− 5 |
| 4.75-mm | 40–45 | X +/− 5 |
| 600-um | 14–19 | X +/− 5 |
| 75-um | — | 2–7 |

TABLE 4
Dense Graded Aggregate

| | Limits of | | | Limits of | |
|---|---|---|---|---|---|
| Sieve | Proposed | Operating | | Proposed | Operating |
| Sizes | Gradation | Range | Sieve Sizes | Gradation | Range |
| 19-mm Maximum, Coarse | | | 12.5-mm Maximum, Medium | | |
| 25-mm | — | 100 | 19-mm | — | 100 |
| 19-mm | — | 90–100 | 12.5-mm | — | 95–100 |
| 9.5-mm | — | 60–75 | 9.5-mm | — | 80–95 |
| 4.75-mm | 45–50 | X +/− 5 | 4.75-mm | 59–66 | X +/− 5 |
| 2.36-mm | 32–36 | X +/− 5 | 2.36-mm | 43–49 | X +/− 5 |
| 600-um | 15–18 | X +/− 5 | 600-um | 22–27 | X +/− 5 |
| 75-um | — | 3–7 | 75-um | — | 3–8 |
| 19-mm Maximum, Medium | | | 9.5-mm Maximum | | |
| 25-mm | — | 100 | 12.5-mm | — | 100 |
| 19-mm | — | 95–100 | 9.5-mm | — | 95–100 |
| 9.5-mm | — | 65–80 | 4.75-mm | 73–77 | X +/− 6 |
| 4.75-mm | 49–54 | X +/− 5 | 2.36-mm | 58–63 | X +/− 6 |
| 2.36-mm | 36–40 | X +/− 5 | 600-um | 29–34 | X +/− 6 |
| 600-um | 18–21 | X +/− 5 | 75-um | — | 3–10 |
| 75-um | — | 3–8 | | | |
| 12.5-mm Maximum, Coarse | | | 4.75-mm Maximum | | |
| 19-mm | — | 100 | 9.5-mm | — | 100 |
| 12.5-mm | — | 95–100 | 4.75-mm | — | 95–100 |
| 9.6-mm | — | 75–90 | 2.36-mm | 72–77 | X +/− 6 |
| 4.75-mm | 55–61 | X +/− 5 | 600-um | 37–43 | X +/− 7 |
| 2.36-mm | 36–40 | X +/− 5 | 75-um | — | 3–12 |
| 600-um | 18–21 | X +/− 5 | | | |
| 75-um | — | 3–7 | | | |

### EXAMPLE 6

### Method:

A. A blend comprised of 87% by weight, PG graded 64-22 asphalt from Albina Asphalt Company, Portland Oreg., that had been heated to 350° F., into which 10% by weight of 80 mesh crumb rubber from BAS Recycling, San Bernadino, Calif. was mixed until it was completely dispersed and then to which a final 3% by weight of LAS99 from Pilot chemical was added. The blend was then milled using a high shear rotor/stator mixer for a period of one hour. Dynamic shear test results revealed the final material graded as a PG 70-22 indicating an increased resistance to deformation at high temperatures than the original asphalt.

B. A blend comprised of 88.1% by weight, PG Graded 64-22 asphalt from Albina Asphalt Company, Portland Oreg., that had been heated to 350° F., into which 10% by weight of 80 mesh crumb rubber from BAS Recycling, San Bernadino, Calif. was mixed until it was completely dispersed and then to which a final 1.9% by weight of Witconic TX from Akzo Nobel, Chicago, Ill. was added. The blend was then milled using a high shear rotor/stator mixer for a period of one hour.

C. A blend comprised of 88.1% by weight, PG Graded 64-22 asphalt from CITGO, Newark, N.J., that had been heated to 350° F., into which 10% by weight of 80 mesh crumb rubber from BAS Recycling, San Bernadino, Calif. was mixed until it was completely dispersed and then to which a final 1.8% by weight of Witconic TX from Akzo Nobel, Chicago, Ill. was added. The blend was then milled using a high shear rotor/stator mixer, Kady International, for a period of one hour. 22° C.

### Result:

Dynamic shear results revealed the RMAC treated with p-TSA graded as a PG 82-10 indicating an increased resistance to deformation at high temperatures than that of the original asphalt and an increased ability to maintain flexibility at temperatures less than 10° C. Dynamic shear results revealed the final RMAC treated with DDBSA graded as a PG 76-22 indicating an increased resistance to deformation at high temperatures than that of the original asphalt and an increased ability to maintain flexibility at temperatures less than

The comparison of RMAC that has been treated with DDBSA to an RMAC treated with p-TSA illustrates that greater physical properties are are obtained using 30% less of a lower weight sulfonic acid. The results of tests of the foregoing blends using a dynamic shear rheometer are illustrated in Table 5.

TABLE 5

| | | |
|---|---|---|
| DSR Result | DDBSA-RMAC | p-TSA-RMAC |

Blended Asphalt Rubber Test Results

| | | |
|---|---|---|
| Temperature | 76° C. | 82° C. |
| G * sinδ | 3.14 | 0.922 |
| Phase Angle | 75.4 | 79.9 |

Blended Asphatl Rubber Test Results After Aging

| | | |
|---|---|---|
| Temperature | 76° C. | 82° C. |
| G * sinδ | 4.88 | 1.45 |
| Phase Angle | 71.8 | 77.3 |

The use of dynamic shear rheometery to measure viscoelastic properties of asphalt for various temperature specifications is well known to those skilled in the art.

### EXAMPLE 7

### Method

A. A blend comprised of 88% by weight of asphalt from Indian Oil Corporation Ltd., New Dehli, India with an penetration grade of 80-100 (@25° C.) was mixed with 10% by weight of crumb rubber made from recycled materials including tires, innertubes, gaskets and scrap acquired from Tinna Oils and Chemicals, Ltd., New Dehli, India, together with 2% by weight of p-TSA from Navdeep Chemicals Pvt. Ltd. Mumbai, India. The asphalt was heated to 390° F. and the crumb rubber was blended into the hot asphalt until completely dispersed. Into that blend, the p-TSA was added and mixed for approximately 10 minutes. The blend was then milled in a rotor/stator laboratory mill, Kady International, for another hour until no particulate was visible in a dilute solution of 100 parts Naptha to 2 parts blend.

B. A blend comprised of 87% by weight of asphalt from Indian Oil Corporation Ltd., New Dehli, India with an penetration grade of 80-100 (@25° C.) was mixed with 10% by weight of crumb rubber made from crmb rubber from recycled tires, BAS Recycling, San Bernardino, Calif. together with 3% by weight of LAS99 (DDBSA), Pilot Chemicals. The asphalt was heated to 390° F. and the crumb rubber was blended into the hot asphalt until completely dispersed. Into that blend, the DDBSA was added and mixed for approximately 10 minutes. The blend was then milled in a rotor/stator laboratory mill, Kady International, for another hour until no particulate was visible in a dilute solution of 100 parts Naptha to 2 parts blend.

### Results

The softening point of the original 80-100 asphalt treated with DDBSA was was raised to 67° C., the penetration lowered to 34 mm, and the elastic recovery was raised from approximately 4% to approximately 56%. The softening point of the original 80-100 asphalt treated with one third less sulfonic acid (p-TSA) raised the penetration of the original asphalt to 48 mm, raised the softening point to 53° C. and the elastic recovery was increased to 55%. In these tests, elastic recovery was measured using a ductilometer pursuant to ASTM D 6084-97 Standard Test Method for Elastic Recovery of Bituminuous Materials by Ductilometer.

### EXAMPLE 8

### Method

2500 grams of PG 64-22 asphalt from CITGO, Newark, N.J. was heated to 350oF. Witconic TX (p-TSA), Akzo Nobel, Chicago, Ill. in the amount of 56.23 grams was mixed into the asphalt and there after 283.71 grams of 80-mesh crumb rubber, BAS Recycling, San Bernardino, Calif. this blend was then milled for a period of one hour using a rotor/stator mixer, Kady International,

### Results

The final blend was then graded in accordance with the Strategic Highway Research Program specifications for asphalt binders. The grade specifications increased and the result was a final PG grade of 76-22. Dynamic shear rheometer and bending beam test results are set forth in Table 6.

TABLE 6

| Test | Result |
|---|---|
| Rotational Viscosity | 1.877 |
| Flash Point, COC, ° C. | 266 |
| Blended Asphalt Rubber | |
| Dynamic Shear Rheometer | |
| G * Sinδ | |
| 76° C. | 1.719 |
| 82° C. | 0.927 |
| RTFO Aged Blended Asphalt | |
| Rubber | |
| Weight Loss % | 0.513% |
| Dynamic Shear Rheometer | |
| G * Sinδ | |
| 76° C. | 3.960 |
| 82° C. | 2.111 |
| PAV Aged @ 110° C. | |
| Dynamic Shear Rheometer | |
| G * Sinδ | |
| 22° C. | 6185 |
| 25° C. | 4718 |
| Bending Beam Rheometer | |
| Stiffness, MPa | |
| −12° C. | 157 |
| −18° C. | 333 |
| m-value | |
| −12° C. | 0.355 |
| −18° C. | 0.294 |
| PG Grade | 76–22 |

### Method

A. A blend of asphalt at 87% by weight, crumb rubber at 10% by weight and DDBSA at 3% by weight was milled until homogenous. The RMAC was then emulsified by milling through a G-3 colloid mill, Chemicolloid Laboratories, Inc., Garden city Park, N.Y. into an anionic aqueous solution. A particle size and distribution was then run on the final emulsion.

B. A blend of asphalt at 88.1% by weight, crumb rubber at 10% by weight and p-TSA at 1.9% by weight was milled until homogenous. The RMAC was then emulsified by milling through a G-3 colloid mill, Chemicolloid Laboratories, Inc., Garden City Park, N.Y. into an anionic aqueous solution. A particle size and distribution was then run on the final emulsion.

C. The foregoing emulsions were formed using identical ratios of asphalt, anionic emulsifier and temperatures.

### Result

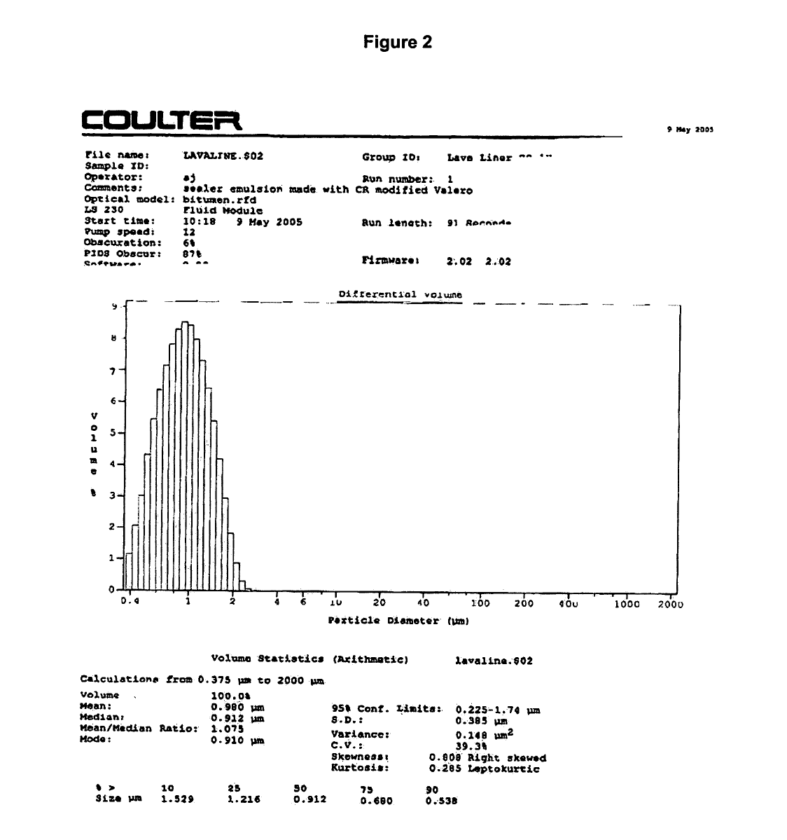

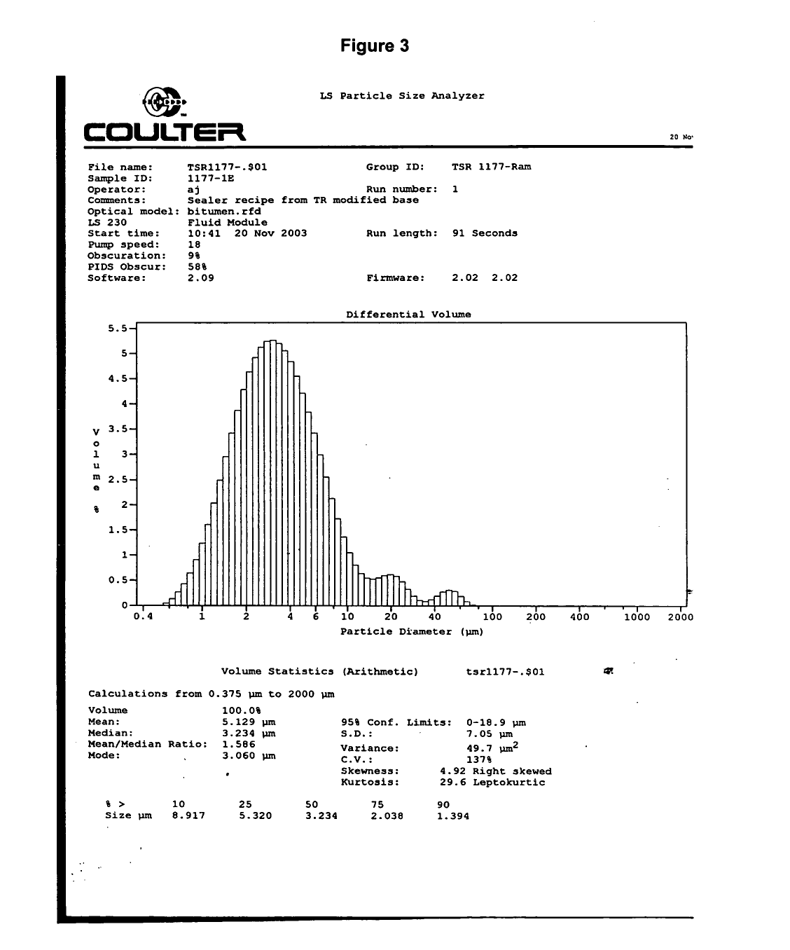

FIGS. 2 and 3 illustrate the decrease in particle size achieved through the emulsified p-TSA-RMAC over the emulsion prepared with DDBSA-RMAC. This decrease in particle size indicates that the RMAC praocess using p-TSA provided an asphalt rubber that was emulsified into a finer and more stable emulsion than the asphalt processed with DDBSA.

Additionally, in some embodiments of the invention, a concentrate or additive containing rubber particles, one ore more sulfonic acid(s) and possibly a quantity of asphalt (e.g., natural asphalt or Gilsonite) may be prepared and subsequently added to a larger quantity of hot asphalt. For example, a concentrate containing about 20-90% rubber particles, about 3-10% of one or more sulfonic acid(s) and the remainder asphalt (e.g., Gilsonite) may be prepared in solid or granular form and shipped to a desired location at which this concentrate may be added to and mixed with a volume of hot asphalt to form a rubber modified asphalt of the present invention.

### DEFINITIONS

The following terms of art used in the present specification and claims are defined as follows:

As used herein, “asphalt” includes bitumen, as well as naturally occurring asphalt, synthetically manufactured asphalt as the by-product of the petroleum refining process, blown asphalts, blended asphalt, residual asphalt, aged asphalt, petroleum asphalt, straight-run asphalt, thermal asphalt, paving grade-asphalt, and the like.

As used herein, “rubber modified asphalt” shall mean any asphalt that contains rubber or to which rubber has been added including but not limited to rubber modified asphalt cement (RMAC).

As used herein, “RMAC” means rubber modified asphalt cement. TRMAC means tire rubber modified asphalt cement. RAC means rubberized asphalt cement. The terms RMAC, TRMAC and RAC are used interchangeably.

As used herein the term “rubber particles” shall mean any particles made substantially of rubber including but not limited to crumb rubber and other particulate forms of rubber (e.g., shavings, fines, beads, etc.) formed of virgin rubber and/or recycled rubber from sources such as tires, innertubes, gaskets, rubber scrap, etc.

As used herein, “blended asphalt rubber” means RVPR and asphalt blends that have been prepared by methods such as those disclosed in U.S. Pat. No. 5,492,561 (Flanigan I), U.S. Pat. No. 5,583,168 (Flanigan II), and U.S. Pat. No. 5,496,400 (Doyle and Stevens) which disclose so-called, “TRMAC” processes for blending RVPR and asphalt. In the TRMAC process, RVPR and asphalt are heated to temperatures in excess of 400□ F. (205□ C.) under carefully controlled conditions that require sophisticated equipment and environmental controls. Flanigan I requires the introduction of oxygen into the mix during admixing and heating; Flanigan II requires that the mixing and heating occur in a vacuum. The Doyle/Stevens process, used by Doyle-Ellis, uses a process in which the PVPR is pretreated with a cross linking agent consisting of tall oil, a strong base, an anhydrous organic solvent and fatty amines prior to being incorporated into hot liquid asphalt. Commercial forms of blended asphalt rubber are available as MAC 10-TR from Paramount Petroleum Company, Paramount, Calif. or Doyle-Ellis, LLC, Bakersfield, Calif.) or AC5-15 TR (also available from Paramount Petroleum Company). The teaching of the present invention includes post addition of sulfonic acids to previously manufactured RMAC to accomplish at least one of the following: (1) an increase the softening point, (2) an increase the hardness, or (3) an increase in recovery from deformation, in the resultant RMAC compositions.

As used herein, “DDBSA-RMAC” means RMAC that has been manufactured using DDBSA.

As used herein, “p-TSA-RMAC” means RMAC that has been manufactured using p-TSA.

As used herein, “RVPR” means recycled vulcanizate (or vulcanized) particulate rubber.

As used herein the term “crumb rubber” or “rubber crumb” shall include all forms of crumbs or beads formed substantially of virgin or recycled rubber.

Certain RVPR classifications incorporated herein are the those published in the American Society for Testing and Materials publication “Standard Classification for Rubber Compounding Materials—Recycled Vulcanizate Particulate Rubber”, Designation: D 5603-96, published January, 1997. In sum, “coarse rubber powders” are products with designations of 425˜m (40 mesh) or larger. Coarse powders typically range in particle size from 2000˜m (10 mesh) to 425˜m (40 mesh) regardless of polymer type or method of processing. “Fine rubber powders” are products with designations of 425□m (40 mesh) or smaller. These materials typically range in particle size from 300□m (50 mesh) to less than 75□m (200 mesh) regardless of polymer type or method of processing. Grades of RVPR are based on olymer/compound types of the parent compounds, with Grades 1, 2 and 3 being the most common, Grades 4, 5 and 6 less common. Grade 1 designates whole tire RVPR prepared from passenger car, truck, and bus tires from which the fiber and metal have been removed. The rubber is then process to the desired particle size. Grade 2 designates RVPR made from so-called “peel rubber”, while Grade 3 designates RVPR made from retread buffings only.

As used herein the words “vulcanizate” and “vulcanized” are used interchangeably.

As used herein, “cured rubber” means a composition consisting of thermoplastic polymer resins having no epoxy groups.

As used herein, “DDBSA” means dodecylbenzene sulfonic acid. DBSA is used interchangeably with DDBSA.

As used herein, “p-TSA” means paratoluene sulfonic acid and can be used interchangeably with TSA or toluene sulfonic acid or 4-Methylbenzenesulronic acid.

As used herein, the term sulfonic acid(s) (SA) refers to members of the group of chemical compounds also known as alkylbenzene sulfonics (AS). For use in the invention, the alkylbenzene sulfonics can be linear (LAS) or branched (BAS). Preferred LAS and BAS compounds for use in the present invention will have from C-1 to about C-20 alkyl derivatives.

Dodecylbenzene has the chemical formula C₁₂H₂₅—C₆H₅. Tridecylbenzene has the chemical formula C₁₃H₂₇—C₆H₅. Toluene has the chemical formula C₇H₈. For use in the present invention, the sulfonic group can be placed on the benzene ring on the carbon atom either next to the toluene, dodecyl or tridecyl group (at the “ortho” position), or on the second carbon atom over from the dodecyl or tridecyl group (at the “meta” position), or on the third carbon atom over from the toluene, dodecyl or tridecyl group (at the “para” position), to give molecules with the formula C₁₂H₂₅—C₆H₄—SO₃H (o-, m- or p-dodecylbenzene sulfonic acid) or C₁₃H₂₇—C₆H₅—SO₃H (o-, m- or p-tridecylbenzene sulfonic acid) or CH₃C₆H₄—SO₃H (p-toluene sulphonic acid).

Dodecyl and tridecyl groups are known as alkyl groups since they are derived from alkanes (dodecane and tridecane, respectively). For use in the present invention, the alkyl groups can be as short as the methyl group CH₃— with only one carbon atom (derived from methane) or as long as the octadecly group with 18 carbon atoms (common in fats) or longer (as found in some heavy crudes). Also for use in the present invention, the alkyl groups can be in the form of straight chains, or may contain any number of side branches of smaller alkyl groups.

As used herein, the terms blending or mixing include methods of combining rubber, asphalt and AS through simple agitation with a propeller or any other mixing apparatus as well as aggressive agitation with high shear and also may include the mixing of asphalt rubber and AS by passing the combination through a colloid or other mill. Such other methods of blending and mixing are known to those skilled in the art. The use of shear and or milling can be used to impart heat to the mixture as well as shorten the time for reaction between the asphalt and rubber through the use of AS.

Although exemplary embodiments of the invention and specific examples have been described, various changes, modifications and substitutions may be made by those having ordinary skill in the art without necessarily departing from the spirit and scope of this invention. Specifically, elements or attributes described in connection with one embodiment or example may also be used in connection with any another embodiment or example, unless otherwise specifically stated, provided that doing so would not render the embodiment or example in which it is incorporated unusable for an intended application. Also, where the steps of a particular method have been described in a particular order, the ordering of such steps may be varied, unless otherwise specifically stated, provided that doing so would not render the embodiment or example in which it is incorporated unusable or otherwise undesirable for an intended application. Accordingly, all such changes, modifications and substitutions to the above-described embodiments and examples are to be included within the scope of the following claims.

What is claimed is:

1. A method for preparing a rubber modified asphalt, said method comprising the steps of:
a. forming a mixture of i) asphalt, ii) rubber particles and iii) at least one sulfonic acid; and
b. heating the mixture to form a rubber modified asphalt.

2. A method according to claim 1 wherein the sulfonic acid is linear.

3. A method according to claim 1 wherein the sulfonic acid is branched.

4. A method according to claim 1 wherein Step B comprises applying moderate heat.

5. A method according to claim 1 wherein the components are heated to a temperature in the range of about 225° to about 450° F.

6. A method according to claim 5 wherein the temperature during Step B is about 350° F.

7. A method according to claim 1 wherein wherein said at least one sulfonic acid comprises one or more sulfonic acids selected from the group consisting of: linear sulfonic acids, branched sulfonic acids, dodecylbenzene sulfonic acid (DDBSA or DBSA), tridecylbenzene sulfonic acid (TDBSA), 4-methylbenzenesulfonic acid, dimethylbenzene sulfonic acid, toluene sulfonic acid, para-toluene sulfonic acid and methane sulfonic acid.

8. A method according to claim 1 wherein Steps A and B are performed substantially simultaneously.

9. A method according to claim 1 wherein Steps A and B are performed substantially separately.

10. A method according to claim 1 wherein Step A comprises initially combining asphalt at least one sulfonic acid with heat and/or mixing and then subsequently adding rubber particles.

11. A method according to claim 1 wherein Step A comprises combining asphalt, rubber particles and at least one sulfonic acid.

12. A method according to claim 9 wherein the rubber particles will pass through a #9 U.S. series sieve.

13. A rubber modified asphalt manufactured by a method according to any of claims 1-12.

14. A method for modifying rubber modified asphalt, said method comprising the step of:
adding at least one sulfonic acid to the rubber modified asphalt.

15. A method according to claim 14 wherein said at least one sulfonic acid comprises one or more sulfonic acids selected from the group consisting of: linear sulfonic acids, branched sulfonic acids, dodecylbenzene sulfonic acid (DDBSA or DBSA), tridecylbenzene sulfonic acid (TDBSA), 4-methylbenzenesulfonic acid, dimethylbenzene sulfonic acid, toluene sulfonic acid, para-toluene sulfonic acid and methane sulfonic acid.

16. A method according to claim 14 further comprising heating the rubber modified asphalt during or after the addition of said at least one sulfonic acid.

17. A method according to claim 16 wherein the rubber modified asphalt is heated to a temperature in the range of about 225° to about 450° F.

18. A method according to claim 17 wherein the temperature is about 350° F. A rubber modified asphalt composition that has been modified by a method according to any of claims 14-18.
